(19) United States
(12) Patent Application Publication
(10) Pub. No.: US 2010/0325290 A1
(43) Pub. Date: Dec. 23, 2010

(54) SYSTEM AND METHOD FOR COORDINATING HUMAN INTERACTION IN SOCIAL NETWORKS

(76) Inventors: Kelsyn D. S. Rooks, Overland Park, KS (US); Jeffrey S. Stafford, Overland Park, KS (US); Jeffrey M. Sweeney, Olathe, KS (US)

Correspondence Address: Woodard, Emhardt, Moriarty, McNett & Henry LLP, 111 Monument Circle, Suite 3700, Indianapolis, IN, 46204-5137, US

(21) Appl. No.: 12/489,050

(22) Filed: Jun. 22, 2009

(51) Int. Cl. G06F 15/173

(52) U.S. Cl. 709/228

(57) ABSTRACT

A method for coordinating human interaction between users within a social network system may include matching users together based on identified compatibility trends. The compatibility trends may be identified based on compatibility research and analysis and/or analysis of previous successful matches. Additionally, the method may include matching users together based on identified personal preferences. The personal preferences may be identified through monitoring the users' interactions with the Internet and determining personal preferences based on the interactions. In a particular embodiment, the social networking system may be a voice-based speed dating network which occurs via voice communications over the Internet.

### FIELD OF THE INVENTION

The present disclosure relates generally to social networking, and more particularly, to coordinating human interaction in social networks.

### BACKGROUND OF THE INVENTION

Social networking is a popular mode of human interaction providing many benefits and opportunities to its users. Social networking allows for users having common interests or goals to interact with each other. Further, the Internet has become an environment in which social networking frequently occurs. Although social networking is increasing in popularity, many social networking providers fail to achieve a considerable number of successful matches. To that end, many social networking providers fail to acquire in-depth information about the users to ensure that successful matches are created. Further, many social networking applications limit the means in which the communication between users occurs.

Accordingly, there is a need for systems and methods for coordinating human interaction in social networks.

### SUMMARY OF THE INVENTION

In certain embodiments, a method for coordinating human interaction within a social network comprises operating a social network, registering a plurality of users for the social network, granting the plurality of users access to the social network, monitoring each of the users' interaction with the Internet, and identifying personal preferences for each of the users based on the interaction with the Internet. Additionally, the method includes matching users based on the identified personal preferences and continually initiating and disabling communications channels through pairs of the matched users to allow for direct communication for a predetermined period of time for each pair.

In certain other embodiments, a method for coordinating human interaction comprises registering a plurality of users for a social network, the social network having at least first and second networking sessions, granting each of the plurality of users access to the social network, and identifying one or more personal preferences for each of the plurality of users. The method additionally includes placing three or more of the plurality of users in the first networking session, rotating the users in the first networking session through pairs to allow for interaction for a predetermined amount of time for each pair, and analyzing the personal preferences of pairs of users in the first networking session that resulted in successful matches. Further, the method includes identifying compatibility trends based on the results of the analyzing, placing three or more of the plurality of users in the second networking session based on the personal preferences of the users and the identified compatibility trends from the first networking session and rotating the users in the second networking session through pairs to allow for interaction for a predetermined amount of time for each pair.

In yet other embodiments, a method for voice-based speed dating comprises registering a plurality of users for a voice-based speed dating social network having a first speed dating session, wherein the first speed dating session occurs via voice communications over a communications network. The method includes granting each of the plurality of users access to the social network, identifying one or more personal preferences for each of the plurality of users, and placing three or more of the plurality of users in the first speed dating session based on the identified personal preferences of the users. Additionally, the method includes rotating the three or more users in the first speed dating session through pairs to allow for direct voice communication for a predetermined amount of time for each pair, providing means for enabling each of the three or more users in the first speed dating session to provide feedback on the other users in the first speed dating session and providing means to allow for additional communication between a pair of users that each provided positive feedback for the other user in the pair.

### BRIEF DESCRIPTION OF THE DRAWINGS

FIG. 1 is a flow chart according to an embodiment of the present disclosure.

FIG. 2 is a flow chart according to an embodiment of the present disclosure.

FIG. 3 is a flow chart according to an embodiment of the present disclosure.

FIG. 4 is a flow chart according to an embodiment of the present disclosure.

FIG. 5 is a flow chart according to an embodiment of the present disclosure.

### DESCRIPTION OF ILLUSTRATED EMBODIMENTS

For the purposes of promoting an understanding of the principles of the disclosure, reference will now be made to the embodiments illustrated and specific language will be used to describe the same. It will nevertheless be understood that no limitation of the scope of the disclosure is thereby intended, such alterations, modifications, and further applications of the principles of the disclosure being contemplated as would normally occur to one skilled in the art to which the disclosure relates.

The present disclosure generally relates to social networking and more specifically relates to coordinating human interaction between users within a social network. In certain embodiments, users participating in the social network system may be matched or paired together based on identified compatibility trends. The compatibility trends may be identified based on compatibility research and analysis and/or analysis of previous successful matches. Additionally, in certain embodiments, users in the social network system may be matched or paired together based on identified personal preferences. The personal preferences may be identified through numerous possible direct and indirect manners, including asking the user a plurality of questions to receive information and/or monitoring the user's interaction with the Internet and determining personal preferences based on that interaction. In a particular embodiment, the social networking system according to the present disclosure may be a voice-based speed dating network which occurs via voice communications over the Internet.

The social network systems discussed and contemplated herein may include communications systems having various elements, features and components used for wireless and/or wired communications. Additionally, communications within the communications systems may occur on a variety of possible networks which may include wireless networks, data or packet networks, cable networks, satellite networks, private networks, publicly switched telephone networks, wired networks or other types of communications networks via one or more communication service providers. In certain embodiments, the communications systems may include servers, routers, switches and/or other network devices for storing data and implementing various aspects of the social network systems. Additionally, the communications systems may include an element or device capable of communication channel control and processing and/or capable of enabling, initiating, routing and/or managing communications between devices. In a particular embodiment, the communications between users are voice-based communications which occur over the Internet or another appropriate global computing network. To enable such communications, the users may employ voice-over-internet-protocol telephones which operate to transfer voice information in digital form, such as packets.

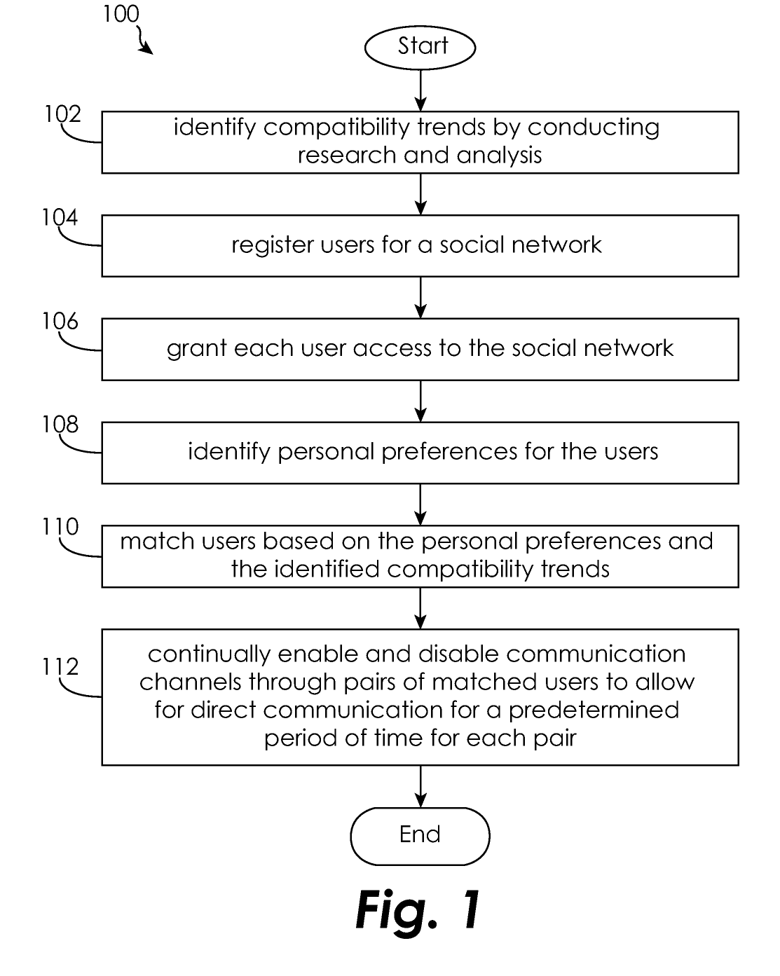

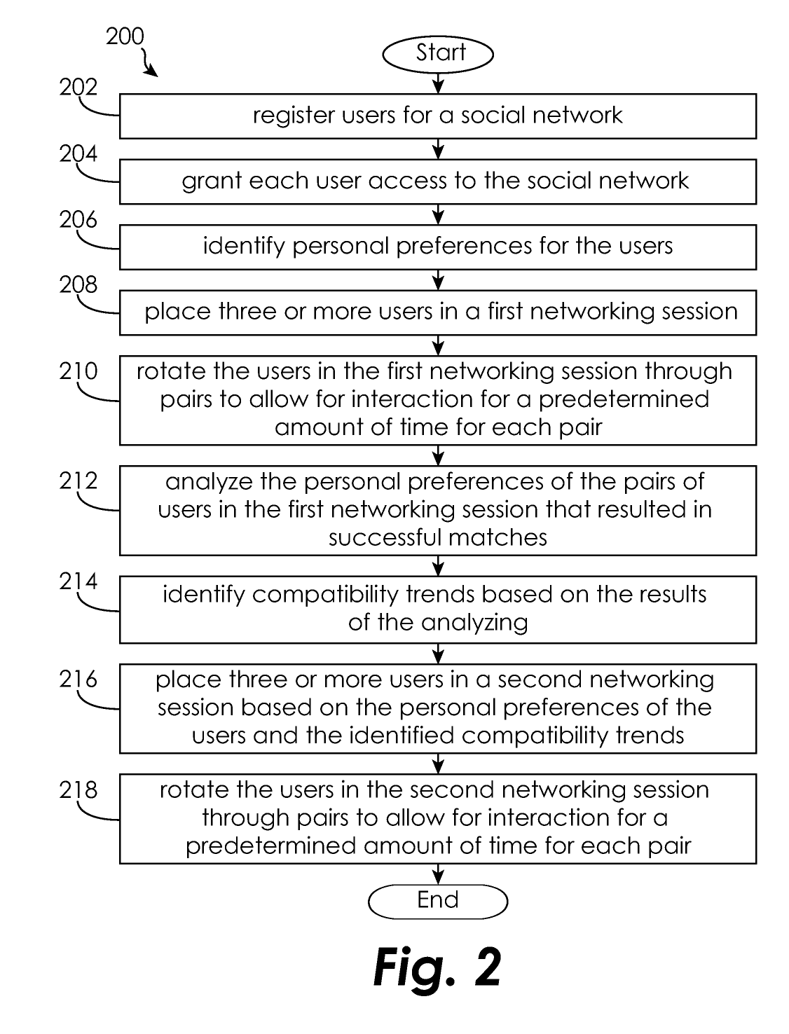

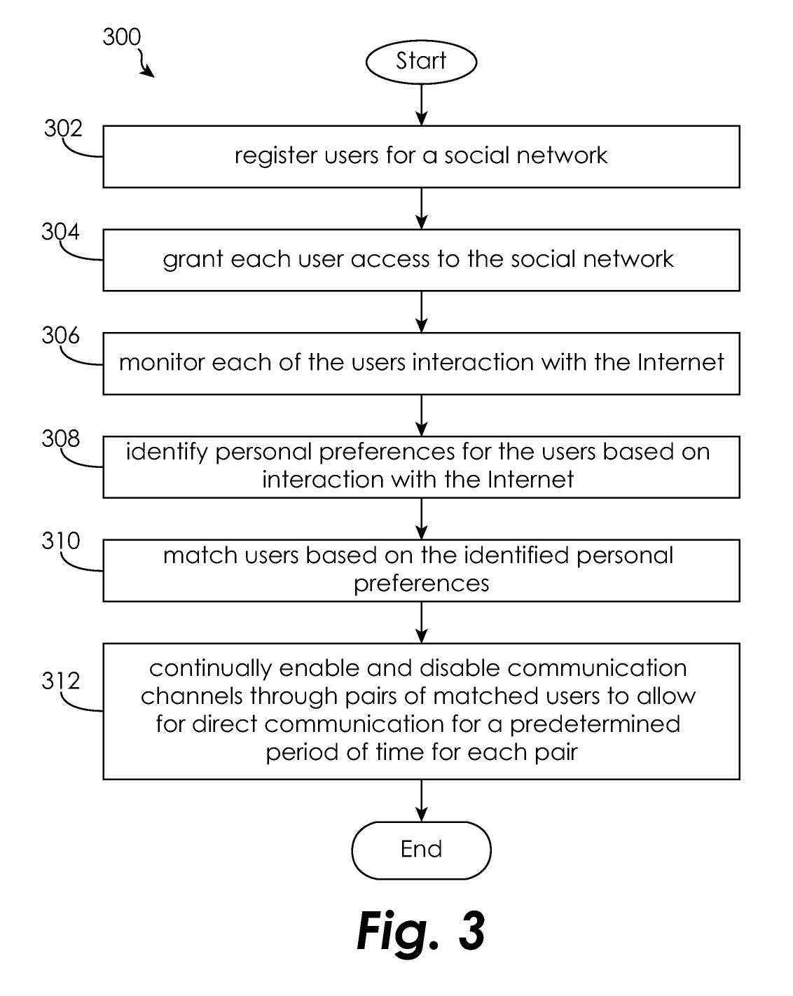

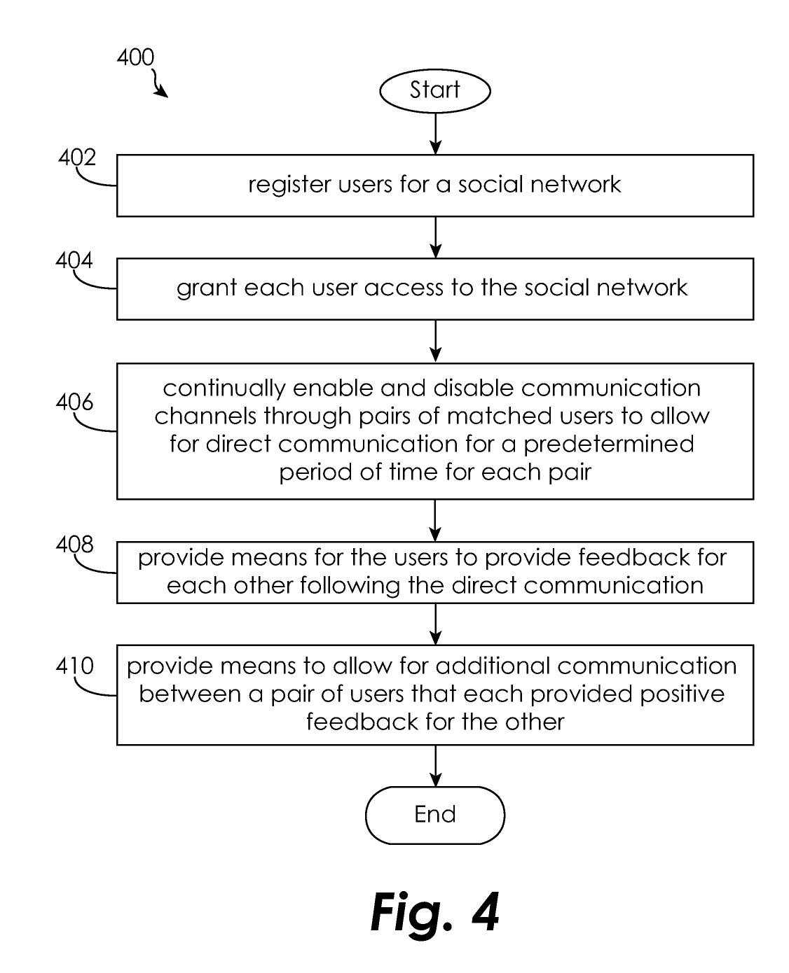

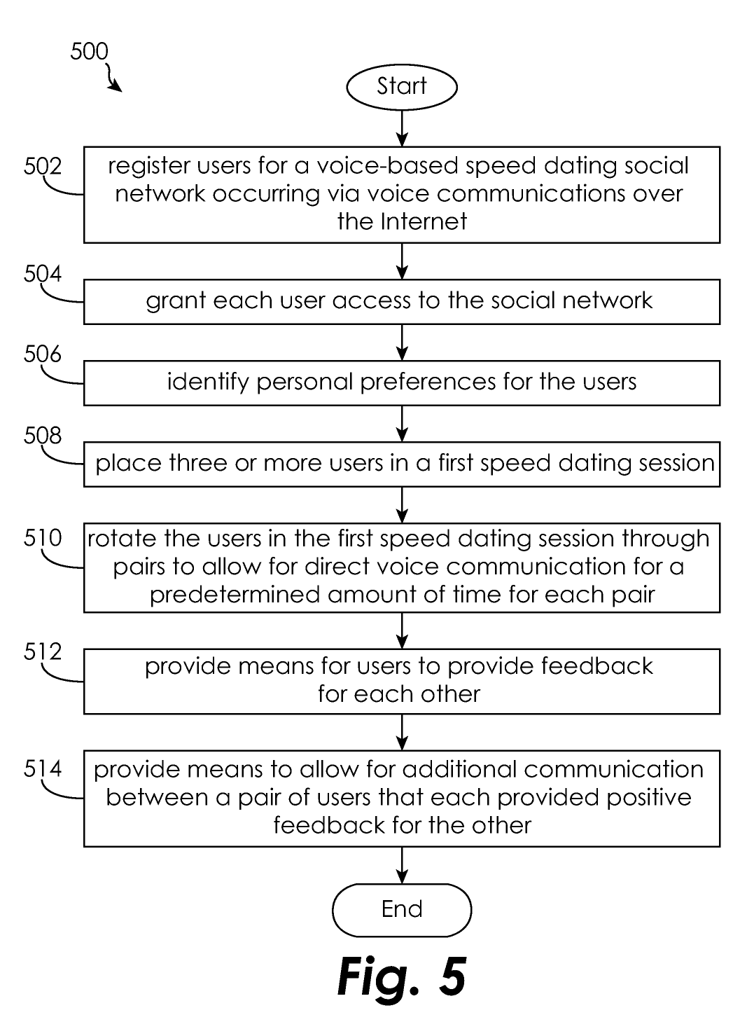

FIGS. 1-5 are flowcharts representing various example methods of coordinating human interaction between users within a social network system according to the present disclosure. More specifically, the flow charts shown in FIGS. 1 and 2 provide overviews of example methods contemplated by the present disclosure in which human compatibility trends may be analyzed and identified. Additionally, the flowchart shown in FIG. 3 represents an example way in which personal preferences of users may be identified. The flowchart shown in FIG. 4 outlines an example method of providing for additional communication between users that provided positive feedback for each other following an initial interaction. Further, the flowchart shown in FIG. 5 provides an overview of an example method contemplated by the present disclosure for voice-based speed dating. It should be appreciated that the timing and/or order of the steps in the flowcharts can be varied as would occur to one of ordinary skill in the art. Additionally, some of the flow charts include many of the same or similar steps as other flow charts. Accordingly, such repeated steps will not be discussed again with respect to the later-occurring flowcharts for the sake of brevity.

Referring to the flowchart shown in FIG. 1, method 100 is directed to a method in which compatibility trends are identified by conducting compatibility research and analysis at step 102. The compatibility research and analysis may be conducted in a variety of appropriate manners utilizing a variety of appropriate techniques. As part of the operation of the social network, at step 104 the system registers users for the social network and at step 106 the system grants the users access to the social network. In certain embodiments, the system may validate or authenticate that the user is authorized to access the social network. The user may be required to supply a password, pass code, account number, pin number, or other appropriate identifier to validate or authenticate the user's ability to participate in the social network.

At step 108, personal preferences for the users are identified. Information regarding the personal preferences of the users may be obtained and/or identified through numerous appropriate manners and techniques, a few examples of which will be discussed in greater detail below. Additionally, the content of the personal preferences may include a variety of interests and profile elements, particular examples of which will also be discussed in greater detail below. Based on the personal preferences and the identified compatibility trends, the system matches users at step 110.

At step 112, the system is operable to continually enable and disable communication channels through pairs of the matched users to allow for direct communication between each pair for a predetermined period of time. In this way, the users may be rotated through pairs until all the users have engaged in direct communication with every other matched user. In such embodiments, a particular user may be matched with multiple other users based on personal preferences and identified compatibility trends. Additionally, in certain embodiments, three or more users may be placed in a particular networking session and rotated through pairs in the networking session to allow for interaction for a predetermined amount of time for each pair. Alternately, the pairs may be allowed interaction for any length of time desired by the users. Further, in certain embodiments, the system may provide procedures for premature disabling of a communication channels if desired by a user. The various types or formats of communication channels contemplated by the present disclosure will be discussed in greater detail below.

Referring to the flowchart shown in FIG. 2, method 200 is directed to a particular example method for identifying compatibility trends for users within a social network system. As part of the operation of the social network, at step 202 the system registers users for the social network and at step 204 the system grants the users access to the social network. At step 206, personal preferences for the users are identified. As mentioned above, information regarding the personal preferences of the users may be obtained and/or identified through numerous appropriate manners and techniques, a few examples of which will be discussed in greater detail below. Based on the personal preferences, the system matches users and places three or more matched users in a first networking session within the social network at step 208. At step 210, the matched users in the first networking session are rotated through pairs to allow for interaction for a predetermined amount of time for each pair.

Following the interaction between pairs, at step 212 the system may be operable recognize successful matches, based on feedback received from the users or other appropriate indications of successful matches, and analyze the personal preferences of the users in pairs that resulted in successful matches. At step 214, compatibility trends may be identified based on the results of the analyzing at step 212. For example, step 212 may reveal that a user having personal preference A matches well with a user having personal preference B, information from which a compatibility trend may be identified. Following the identification of compatibility trends based on successful matches, at step 216 the system may place three or more users in a second networking session based on the personal preferences of the users and the identified compatibility trends and, at step 218, rotate the users through pairs to allow for interaction. In this way, the system may be operable to analyze previous successful matches to identify compatibility trends and use such information to match additional users in future sessions. This pattern may continue as additional compatibility trends are identified based on further successful matches.

Furthermore, the system may be operable to analyze unsuccessful matches in addition to successful matches to create new matches in future sessions. For example, unsuccessful matches may be analyzed to determine characteristics or preferences to be avoided for certain users. This information may be used, for example, to eliminate potential matches.

The length of the network sessions may vary dramatically from as short as a few minutes to as long as days, weeks, or longer. Furthermore, the time period of each network session may be predetermined without input from the participants, or may be determined partially or entirely by input from the participants. By way of example and not limitation, participants may be informed that a network session will commence on a given date and time and conclude on a given date and time. Alternatively, participants may indicate a preferred start date and time as well as availability after the start date and time. Participants may indicate availability in advance and/or as their availability arises.

Method 300 shown in the flowchart in FIG. 3 is directed to a method for obtaining information to identify personal preferences for users within a social network. As part of the operation of the social network, at step 302 the system registers users for the social network and at step 304 the system grants the users access to the social network. At step 306, the system monitors the users' interaction with the Internet. The monitoring may be performed in a variety of appropriate manners and through a variety of appropriate techniques as would occur to one of ordinary skill in the art. In certain embodiments, as part of registering for the social network the users each give their permission to have their Internet usage monitored as part of the operation of the social network. Based on the Internet interaction, at step 308 the system may be operable to identify personal preferences for the users. In certain embodiments, the system may monitor the websites that each user visits and identify personal preferences based on the types of websites visited. In other embodiments, the system may monitor the purchases that each user makes over the Internet and identify personal preferences based on the types of purchases made. It is contemplated that the system may identify personal preferences based on Internet usage in a variety of possible manners as would occur to one of ordinary skill in the art. At step 310, the system may then match users based on their identified personal preferences. At step 312, the system continually enables and disables communication channels through pairs of the matched users to allow for direct communication between each pair for a predetermined period of time, similar to step 112 discussed in greater detail above. In other embodiments, in addition to or in lieu of monitoring Internet usage, the social networking system may identify personal preferences of users by providing prompts, questions, selections or other interfacing elements designed to receive information from the user to identify personal preferences.

Referring to the flowchart shown in FIG. 4, method 400 is directed to a particular example method for allowing for user feedback following communications and allowing for additional communication between successful matches. As part of the operation of the social network, at step 402 the system registers users for the social network and at step 404 the system grants the users access to the social network. At step 406, the system continually enables and disables communication channels through pairs of users to allow for direct communication between each pair for a predetermined period of time, similar to steps 112 and 312 discussed in greater detail above. At step 408, the system may provide means for enabling the users to provide feedback on each other following their communications. In certain embodiments, the system may prompt the users to provide feedback for the other user in a particular pair immediately following the disabling of the corresponding communication channel. In other embodiments, the system may prompt each user to provide feedback for multiple other users at the end of a particular networking session. There are numerous possible manners in which users may provide feedback for other users. In certain embodiments, each user may provide a yes or no indication for each of the other users. The yes or no indication may represent whether or not the user viewed the interaction as a successful match and/or whether or not the user wants to engage in further communications with a particular user. It is contemplated that in other embodiments the system may allow for users to provide other types of indications of positive or negative feedback for other users.

Additionally, in certain embodiments, the system may provide means for allowing for additional communication between a pair of users that each provided a type of positive feedback for the other user, at step 410. In a particular embodiment, the system may provide access codes to the users allowing them to contact each other again in the future. However, it should be appreciated that the system may provide other appropriate means to allow for additional contact between users as would occur to one of ordinary skill in the art. In embodiments in which access codes are provided, the system may allow for deactivation of the codes by either user at any time to prevent further communication between the users. Additionally, the supplemental contact may occur a time specified by the social network system or at a point in time in the future at the users' choosing.

The methods and systems discussed herein may be implemented with respect to a variety of social networking systems as would occur to one of ordinary skill in the art. To name a few non-limiting examples, the social network system may be a professional networking system, a dating network, a hobby or interest-based network, a geographic or location-based network, a friendship network, or a speed dating network. Additionally, it is contemplated that the interactions between users may occur via a variety of appropriate communication formats, including voice-based, video conferencing, face-to-face, text, email, and instant messaging, to name a few non-limiting examples. Method 500 shown in the flowchart in FIG. 5 provides an example method of implementing the systems and methods discussed herein with respect to a speed dating network. The example method 500 is directed to a voice-based speed dating network with interactions occurring via voice communications over the Internet.

As part of the operation of the voice-based speed dating network, at step 502 the system registers users for the social network and at step 504 the system grants the users access to the social network. At step 506, personal preferences for the users are identified. As mentioned above, information regarding the personal preferences of the users may be obtained and/or identified through numerous appropriate manners and techniques. Based on the personal preferences, the system matches users and places three or more matched users in a first speed dating session at step 508. At step 510, the matched users in the first speed dating session are rotated through pairs to allow for direct voice communication for a predetermined amount of time for each pair. In certain embodiments, the users may utilize voice over internet protocol (“VoIP”) telephones to conduct the voice communications with other users. To engage in the direct voice-based communication with other users, the users may access the social network system in a variety of appropriate manners, including by dialing a designated telephone number or by making a selection through a VoIP telephone, as examples.

At step 512, the system may optionally provide means for enabling the users to provide feedback on each other following their communications, as discussed above with respect to step 408 of method 400. Additionally, at step 514 the system may optionally provide means for allowing for additional communication between a pair of users that each provided positive feedback for the other, as discussed above with respect to step 410 of method 400.

As mentioned above, the personal preferences of the users may include a variety of interests, information, criteria and/or profile elements as would occur to one of ordinary skill in the art. To name a few non-limiting examples, the personal preferences may include one or more of the following profile elements: age, gender, religion, marital status, dating status, number and ages of children, political beliefs, occupation, spoken language, sexual orientation, and occupation. Additionally, to name a few non-limiting examples, the personal preferences may include one or more of the following interests: sports, religion, politics, current events, entertainment, music, movies, television shows, board games, video games, internet games, pets, wildlife, pets, animals, travel, history, architecture, sewing, photography, art, mentoring, and nutrition. The information regarding personal preferences may also include contact preferences, such as how and when the user is to be contacted and/or how and when the user desires to engage in interaction with other users. Additionally, the information may include other types of preferences, such as information regarding the user's dating preferences and/or lifestyle preferences, including occupation, pets, children, living arrangements, and pastimes to name a few non-limiting examples. Further, the personal preferences may include information regarding the communication format the user is willing to engage in. In certain embodiments, the personal preferences may include any information that may be submitted by a user.

In certain embodiments, each user within a social network system may be permitted to update, configure or modify the user's profile stored by the social network system and/or set preferences, implement changes or perform other updates or changes as desired. In some embodiments, the social network system may be accessible via the Internet, with the user being permitted to access the user's profile via the Internet. In such embodiments, the user may be required to supply a password, pass code, account number, pin number, or other appropriate identifier to access the user's profile within the social network system.

In certain embodiments, the various social network systems discussed above may provide for secure connections between users to protect the privacy of the users. The secure connections may allow for interaction between users in such a manner as to ensure that personal, private or any type of identifying information, including the names of the users and their personal preferences, is not exchanged or otherwise transmitted to other users in the social network without the explicit permission of the particular user. In this way, the secure connections maintain the privacy and security of the users of the social network system. Additionally, the secure connections allow the social network systems to provide for anonymous interactions between users. In alternative embodiments, the social network systems may provide user names or profiles to other users before, during and/or following the interaction between users.

Additionally, the social network systems may operate one or more safety measures or safeguards for protecting the privacy and security of the users. In certain embodiments, the system may provide means for reporting abuse of the system, provide means for disabling communication or interaction with specific users and/or provide means for reporting inappropriate conduct of users. In a particular embodiment, the social network systems may provide means for terminating or disabling a communication channels at any time for any reason by either user. Additionally, in certain embodiments, the social network systems may allow a user to mask the user's voice to provide additional security and privacy to the user's interactions with others.

While the disclosure has been illustrated and described in detail in the drawings and foregoing description, the same is to be considered as illustrative and not restrictive in character, it being understood that only the preferred embodiment has been shown and described and that all changes and modifications that come within the spirit of the disclosure are desired to be protected.

What is claimed is:

1. A method for coordinating human interaction within a social network, comprising:
operating a social network;
registering a plurality of users for the social network,
granting the plurality of users access to the social network;
monitoring each of the users' interaction with the Internet;
identifying personal preferences for each of the users based on the interaction with the Internet;
matching users based on the identified personal preferences; and
continually initiating and disabling communications channels through pairs of the matched users to allow for direct communication for a predetermined period of time for each pair.

2. The method of claim 1, wherein the monitoring interaction with the Internet includes monitoring purchases made by the users over the Internet.

3. The method of claim 1, wherein the monitoring interaction with the Internet includes monitoring websites visited by the users over the Internet.

4. The method of claim 1, further comprising providing means for enabling each of the users to provide feedback on the other user in each corresponding pair following the direct communication.

5. The method of claim 4, further comprising identifying compatibility trends between humans by analyzing the personal preferences of pairs of users that provided positive feedback for each other and determining compatibility trends based on the results of the analyzing.

6. The method of claim 4, further comprising providing means to allow for additional communication between a pair of users that each provided positive feedback for the other user in the pair.

7. The method of claim 4, wherein the feedback is either a yes or no indication.

8. The method of claim 1, wherein the social network is a voice-based speed dating network, wherein the speed dating network occurs via voice communications over the Internet.

9. The method of claim 8, wherein the voice communications over the Internet occur through a voice over internet protocol (VoIP) telephone.

10. A method for coordinating human interaction, comprising:
registering a plurality of users for a social network, the social network having at least first and second networking sessions;
granting each of the plurality of users access to the social network;
identifying one or more personal preferences for each of the plurality of users;
placing three or more of the plurality of users in the first networking session;
rotating the users in the first networking session through pairs to allow for interaction for a predetermined amount of time for each pair;
analyzing the personal preferences of pairs of users in the first networking session that resulted in successful matches;
identifying compatibility trends based on the results of the analyzing;
placing three or more of the plurality of users in the second networking session based on the personal preferences of the users and the identified compatibility trends from the first networking session; and
rotating the users in the second networking session through pairs to allow for interaction for a predetermined amount of time for each pair.

11. The method of claim 10, further comprising providing means for enabling each of the users in the first and second networking sessions to provide feedback on the other users in the corresponding networking session following the interactions.

12. The method of claim 11, wherein each of the successful matches includes a pair of users that each provided positive feedback for the other user in the pair.

13. The method of claim 11, further comprising providing means to allow for additional communication between a pair of users that each provided positive feedback for the other user in the pair.

14. The method of claim 10, wherein the social network occurs via voice communications over the Internet.

15. The method of claim 10, wherein the identifying one or more personal preferences includes monitoring each of the users' interaction with the Internet and identifying personal preferences based on the interaction with the Internet.

16. A method for voice-based speed dating, comprising:
registering a plurality of users for a voice-based speed dating social network having a first speed dating session, wherein the first speed dating session occurs via voice communications over a communications network;
granting each of the plurality of users access to the social network;
identifying one or more personal preferences for each of the plurality of users;
placing three or more of the plurality of users in the first speed dating session based on the identified personal preferences of the users;
rotating the three or more users in the first speed dating session through pairs to allow for direct voice communication for a predetermined amount of time for each pair;
providing means for enabling each of the three or more users in the first speed dating session to provide feedback on the other users in the first speed dating session; and
providing means to allow for additional communication between a pair of users that each provided positive feedback for the other user in the pair.

17. The method of claim 16, wherein the identifying one or more personal preferences includes tracking each of the users interaction with the Internet and determining preferences based on the interaction with the Internet.

18. The method of claim 16, further comprising analyzing the personal preferences of pairs of users that each provided positive feedback for the other in the corresponding pair and identifying compatibility trends based on the results of the analyzing.

19. The method of claim 16, wherein the voice communications occur via voice communications over the Internet.

20. The method of claim 16, wherein the voice communications occur through a voice over internet protocol (VoIP) telephone.

21. The method of claim 16, wherein the providing means to allow for additional communication includes providing each the users an access code allowing the users to contact each other.
